(19) United States
(12) Patent Application Publication
(10) Pub. No.: US 2019/0311417 A1
(43) Pub. Date: Oct. 10, 2019

(54) Systems And Methods For Smart Vending In Vehicles

(71) Applicant: DENSO International America, Inc., Southfield, MI (US)

(72) Inventors: Greg RANDISI, Huntington Woods, MI (US); Zhe HUANG, Troy, MI (US); Joseph LULL, South Haven, MI (US); Kyle GOLSCH, Pontiac, MI (US)

(21) Appl. No.: 16/271,075

(22) Filed: Feb. 8, 2019

Related U.S. Application Data
(60) Provisional application No. 62/655,404, filed on Apr. 10, 2018.
(60) Provisional application No. 62/662,896, filed on Apr. 26, 2018.
(60) Provisional application No. 62/729,628, filed on Sep. 11, 2018.

(51) Int. Cl. G06Q 30/06; H04W 4/23; G06Q 50/30

(52) U.S. Cl. CPC G06Q 30/0631; G06Q 50/01; G06Q 50/30; H04W 4/23

(57) ABSTRACT

A system is disclosed and includes a processor configured to execute instructions stored in a nontransitory memory. The instructions include receiving recommendation information from at least one of a ride-hailing computing system and a portable device. The recommendation information includes information associated with a user of the portable device, a time, a date, and portable device activity information. The instructions also include receiving destination information associated with the user. The instructions also include generating a product recommendation based on at least a portion of the recommendation information and the destination information. The instructions also include determining whether a vending apparatus located in a vehicle includes a product associated with the product recommendation. The instructions also include, in response to determining that the vending apparatus includes the product, transmitting the product recommendation to the portable device.

### CROSS-REFERENCE TO RELATED APPLICATIONS

This application claims the benefit of U.S. Provisional Application No. 62/655,404, filed on Apr. 10, 2018; U.S. Provisional Application No. 62/662,896, filed on Apr. 26, 2018; and U.S. Provisional Application No. 62/729,628, filed on Sep. 11, 2018. The entire disclosures of each of the above applications are incorporated herein by reference.

### FIELD

The present disclosure relates to in-vehicle smart vending systems.

### BACKGROUND

This section provides background information related to the present disclosure and is not necessarily prior art.

As autonomous vehicles and ride-hailing, ride-sharing, and vehicle-sharing services become more ubiquitous, passengers of these vehicles will be presented with new opportunities to interact with the respective vehicle. As an example, these vehicles may provide goods using an in-vehicle vending system, custom entertainment, and/or comfort services to each of the respective passengers.

### SUMMARY

This section provides a general summary of the disclosure, and it is not a comprehensive disclosure of its full scope or all of its features.

A system is disclosed and includes a processor configured to execute instructions stored in a nontransitory memory. The instructions include receiving, using the processor, recommendation information from at least one of a ride-hailing computing system and a portable device, wherein the recommendation information includes information associated with a user of the portable device, a time, a date, and portable device activity information. The instructions also include receiving, using the processor, destination information associated with the user. The instructions also include generating, using the processor, a product recommendation based on at least a portion of the recommendation information and the destination information. The instructions also include determining, using the processor, whether a vending apparatus located in a vehicle includes a product associated with the product recommendation. The instructions also include, in response to determining that the vending apparatus includes the product, transmitting, using the processor, the product recommendation to the portable device.

In some embodiments, generating the product recommendation further comprises: determining, using the processor, a destination and characteristics associated with the destination based on the destination information; and generating, using the processor, the product recommendation based on the characteristics associated with the destination.

In some embodiments, generating the product recommendation further comprises: identifying, using the processor, the user; determining, using the processor, a destination based on the destination information; and determining, using the processor, whether the user is associated with a social media account. Generating the product recommendation also includes, in response to determining that the user is associated with the social media account, determining, using the processor and by referencing a vehicle request database associated with the ride-hailing computing system, whether a social media connection of the user has made a vehicle request, wherein the vehicle request includes destination information corresponding to the destination; and generating, using the processor, the product recommendation based on whether the social media connection of the user has made the vehicle request.

In some embodiments, generating the product recommendation further comprises: determining, using the processor, a destination based on the destination information; retrieving, using the processor and by referencing a weather application, weather information associated with the destination; and generating, using the processor, the product recommendation based on the weather information.

In some embodiments, generating the product recommendation further comprises: determining, using the processor, a rush factor score based on the portable device activity information, wherein the portable device activity information represents at least one of movement data associated with the portable device and usage data associated with the portable device; and generating, using the processor, the product recommendation based on the rush factor score.

In some embodiments, the instructions further comprise generating, using the processor, a service recommendation based on at least the portion of the recommendation information and the destination information.

In some embodiments, generating the service recommendation further comprises: determining, using the processor, a destination based on the destination information; determining, using the processor and by referencing a dynamic event database, whether the destination is associated with an event; determining, using the processor and by referencing a vehicle request database, whether the user has made a vehicle request associated with an end time of the event; and in response to determining that the user has not made the vehicle request, generating, using the processor, the service recommendation associated with a ride-hailing service corresponding to the end time of the event.

Another system is disclosed and includes a processor configured to execute instructions stored in a nontransitory memory. The instructions include receiving, using the processor, a vehicle request from a portable device; and obtaining, using the processor, contextual information, wherein the contextual information includes: user information associated with a user of the portable device, wherein the user information includes user profile information and purchase history information; and route information, location information, and time information associated with the vehicle request. The instructions also include identifying, using the processor, at least one product based on at least one of the vehicle request and the contextual information; selecting, using the processor, a vehicle from a plurality of vehicles based on the at least one product; determining, using the processor, whether the vehicle includes the at least one product; and in response to the vehicle not including a threshold amount of the at least one product, transmitting, using the processor, a request to at least one of the vehicle and a portable device associated with an operator of the vehicle, wherein the request is configured to cause the at least one of the vehicle and the portable device to generate an output indicating that the vehicle needs to be supplied with the at least one product prior to arriving at a location associated with the user.

In some embodiments, the instructions include, in response to a user of the portable device making a purchase of the at least one product, updating, using the processor, a blockchain network based on the purchase.

In some embodiments, selecting the vehicle further comprises: retrieving, using the processor, inventory information associated with each vehicle of the plurality of vehicles; retrieving, using the processor, location information associated with each vehicle of the plurality of vehicles; and selecting, using the processor, the vehicle based on the location information associated with each vehicle of the plurality of vehicles and the inventory information.

In some embodiments, selecting the vehicle further comprises retrieving, using the processor, operation information associated with each vehicle of the plurality of vehicles.

In some embodiments, the instructions include, in response to the vehicle not including the threshold amount of the at least one product, identifying, using the processor, at least one of a supplier and retailer that includes the at least one product.

In some embodiments, the request is configured to cause the vehicle to automatically proceed to a location associated with at least one of the supplier and the retailer.

In some embodiments, the purchase history information represents purchases that are associated with the user and that were made within a threshold period of time.

An apparatus is disclosed and includes a processor configured to execute instructions stored in a nontransitory memory. The instructions include receiving, using the processor, motion data from a haptic sensor, wherein the motion data indicates at least one of a vibration of a vending apparatus and movement of the vending apparatus; receiving, using the processor, image data from a camera; and determining, using the processor, whether the vending apparatus is subject to malicious activity based on at least one of the motion data and the image data. The instructions also include, in response to determining that the vending apparatus is subject to malicious activity: activating, using the processor, a locking mechanism of the vending apparatus; generating, using the processor, an alert corresponding to the malicious activity; and transmitting, using the processor, the alert to at least one of (i) a portable device associated with an operator of a vehicle that includes the vending apparatus, and (ii) a control module of the vehicle.

In some embodiments, the instructions include determining, using the processor, state information associated with the locking mechanism.

In some embodiments, determining that the vending apparatus is subject to malicious activity further comprises determining, using the processor, the image data corresponds to at least one of a location and a movement of a user that is associated with the malicious activity.

In some embodiments, determining that the vending apparatus is subject to malicious activity further comprises determining, using the processor, the image data corresponds to a user impermissibly retrieving products from the vending apparatus.

In some embodiments, determining that the vending apparatus is subject to malicious activity further comprises determining, using the processor, the motion data corresponds to a user attempting to move the vending apparatus from a first location.

In some embodiments, determining that the vending apparatus is subject to malicious activity further comprises determining, using the processor, the state information corresponds to a user attempting to impermissibly access products of the vending apparatus.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and the drawings are not intended to limit the scope of the present disclosure.

FIGS. 1A-1B illustrate an example vehicle routing system according to the present disclosure.

FIG. 2 illustrates a functional block diagram of an example vehicle routing system according to the present disclosure.

FIG. 3 illustrates a flowchart of an example control algorithm according to the present disclosure.

FIG. 4 illustrates a functional block diagram of an example vending apparatus located within a ride-hailing vehicle according to the present disclosure.

FIG. 5 illustrates a functional block diagram of an example vending apparatus located within a ride-hailing autonomous vehicle according to the present disclosure.

FIG. 6 illustrates a detailed functional block diagram of an example vending apparatus according to the present disclosure.

FIG. 7 illustrates a flowchart of an example control algorithm according to the present disclosure.

FIG. 8 illustrates detailed functional block diagram of an example product recommendation module of the vending apparatus according to the present disclosure.

FIG. 9 illustrates a flowchart of an example control algorithm according to the present disclosure.

Corresponding reference numerals indicate corresponding parts throughout the several views of the drawings.

### DETAILED DESCRIPTION

Example embodiments will now be described more fully with reference to the accompanying drawings.

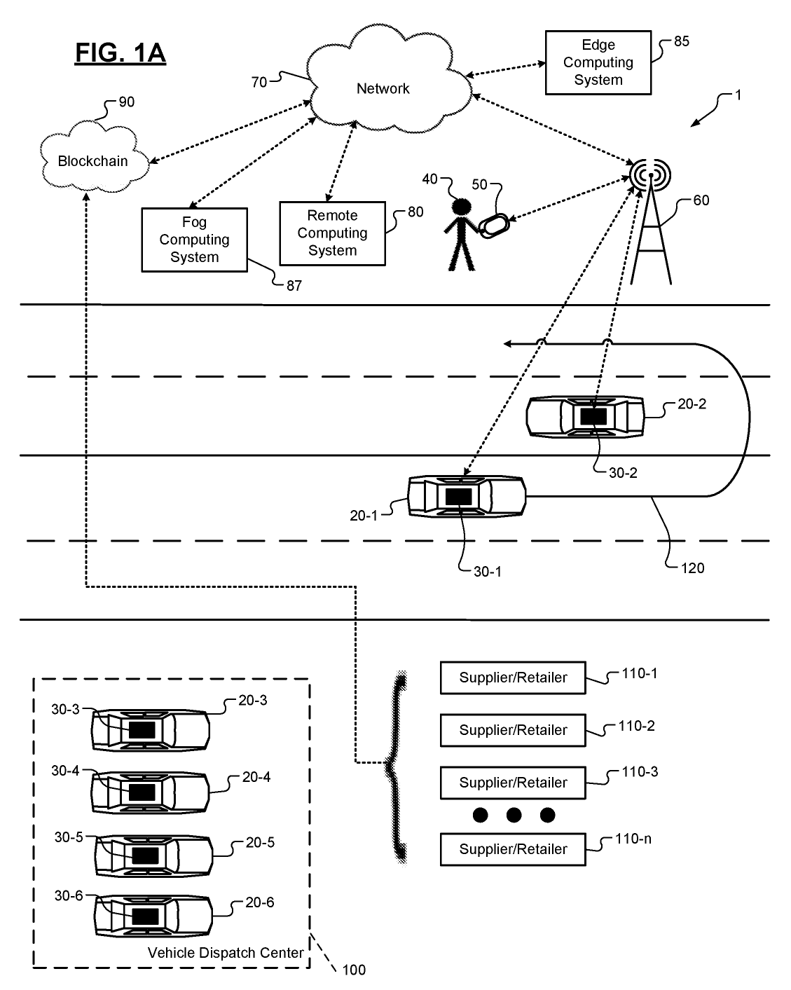

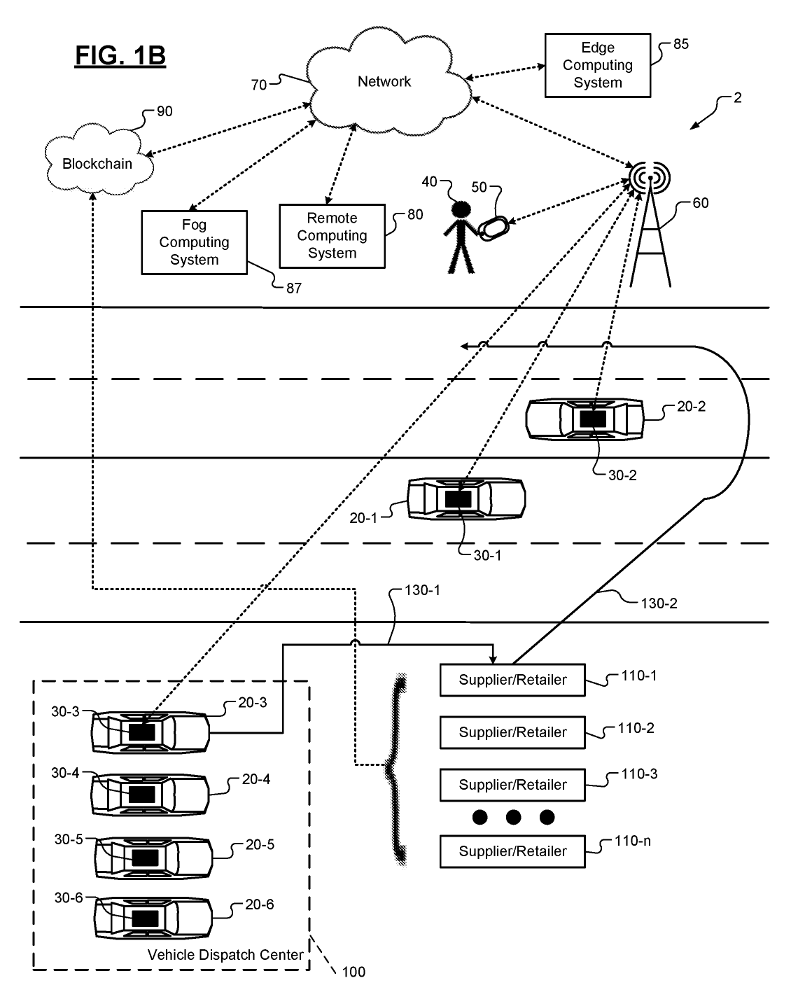

With reference to FIG. 1A, an example vehicle routing system 1 is shown. The vehicle routing system 1 may include vehicles 20-1, 20-2, 20-3, 20-4, 20-5, 20-6 (collectively referred to as vehicles 20), and the vehicles 20 may each include a respective vending apparatus 30-1, 30-2, 30-3, 30-4, 30-5, 30-6 (collectively referred to as vending apparatuses 30). The vehicles 20 may be implemented by, for example, autonomous vehicles, semi-autonomous vehicles, ride-sharing vehicles, and/or ride-hailing vehicles. Example ride-hailing vehicles may be vehicles that are associated with a ride-hailing company, such as UBER®, LYFT®, etc.

The vending apparatuses 30 may be located at any suitable location within the respective vehicles 20, such as between a driver seat and a passenger seat of the vehicle 20. The vending apparatuses 30 store products, such as refreshments and snacks, and the products are available for purchase by a passenger of the respective vehicle 20.

The vending apparatus 30 may also be configured to communicate product information of the vending apparatus 30 to a remote computing system 80 via a network 70. As an example and as indicated by the dashed arrow between the vending apparatus 30-2 and communication infrastructure 60, using a wireless transceiver system (shown below), the vending apparatus 30-2 may transmit wireless signals (e.g., cellular/LTE signals, 5G signals, Wi-Fi signals, Bluetooth low energy (BLE) signals, and/or other telemetric signals) representing inventory information of the vending apparatus 30-2, transaction information associated with the vending apparatus 30-2, and other relevant information to the remote computing system 80 via the network 70 and the communication infrastructure 60 (e.g., a cellular tower). Likewise, vending apparatuses 30-1, 30-3, 30-4, 30-5, 30-6 may transmit wireless signals representing the inventory information, the transaction information, and other relevant information to the remote computing system 80 via the network 70 and the communication infrastructure 60.

Additionally or alternatively, the vending apparatus 30 may be configured to communicate product information of the vending apparatus 30 to an edge computing system 85 and/or a fog computing system 87 via the network 70 in order to avoid latency issues of a cloud computing network. Example edge computing systems are described in detail in U.S. Pat. No. 10,099,637, filed on Oct. 9, 2017 and assigned to DENSO International America, Inc., which is incorporated herein by reference in its entirety.

The remote computing system 80 is also configured to receive, via the communication infrastructure 60 and the network 70, vehicle requests from a portable device 50 associated with user 40. The portable device 50 may be any device that is configured to transmit and receive wireless signals. As an example, the portable device 50 may be a smartphone, smartwatch, wearable electronic device, laptop, desktop computer, tablet device, key fob, or Bluetooth-enabled device. The portable device 50 includes at least one processor that is configured to execute instructions stored in a nontransitory computer-readable medium, such as a read-only memory (ROM) and/or random-access memory (RAM).

In one example embodiment, the user 40 generates, using an application being executed by the portable device 50, the vehicle request. As defined herein, the vehicle request is a request for one of the vehicles 20 to transport the user 40 from a first location to a second location. The vehicle request includes contextual information, which may include at least one of location information (e.g., a current location of the user 40); date and/or time information (e.g., a date and time the vehicle request was made); and user information (e.g., account information associated with the user 40, such as identification, billing, and purchase history information).

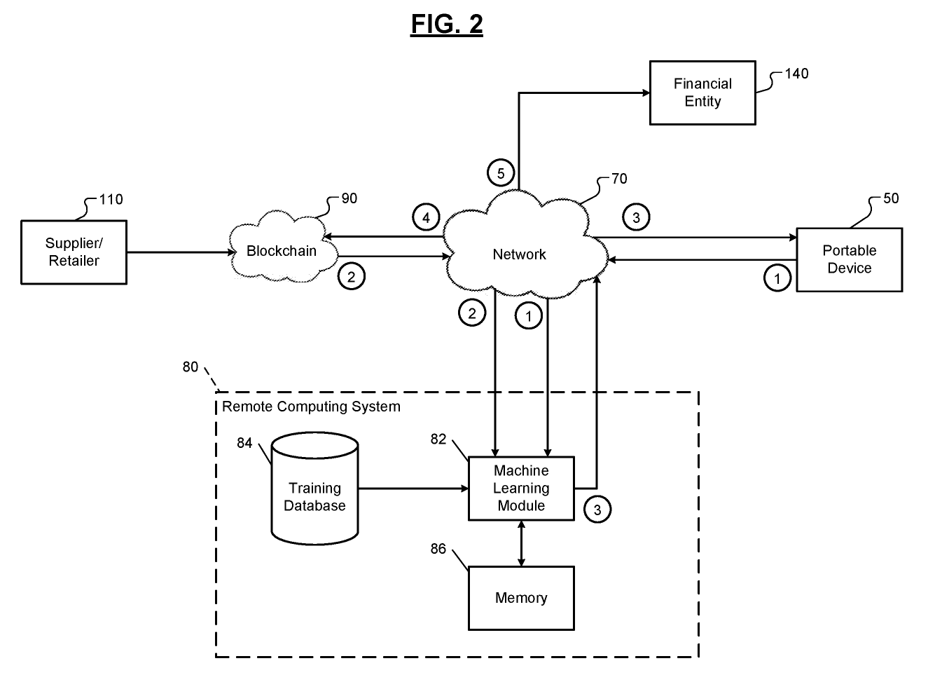

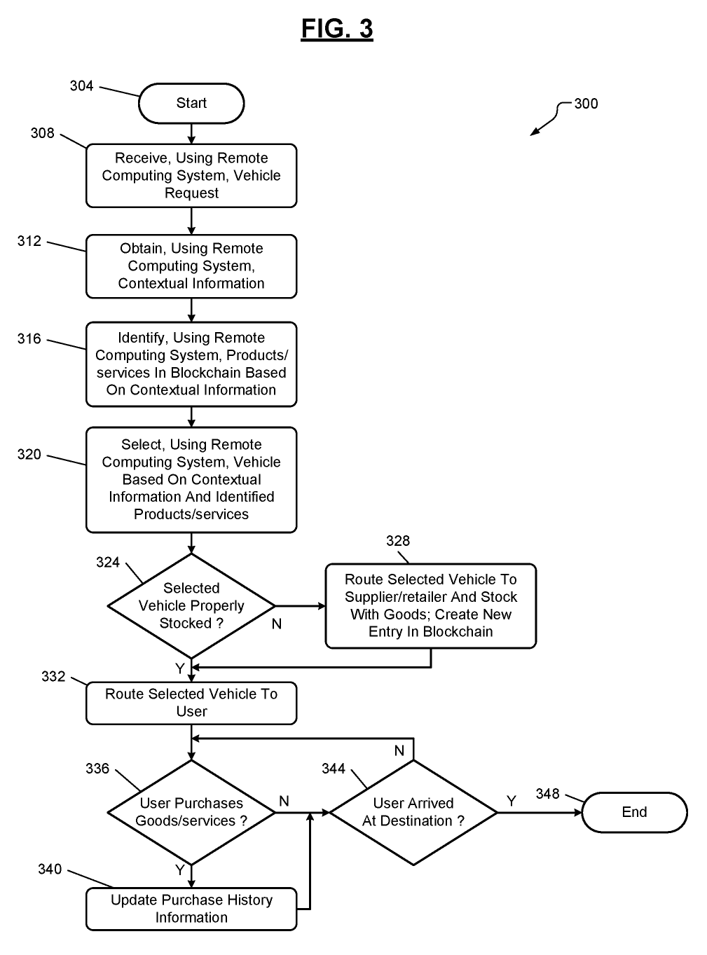

In response to receiving and based on the vehicle request, the remote computing system 80 may identify and assign one of the vehicles 20 to the user 40. The vehicle 20 may be a vehicle that is currently in operation on a roadway (one of vehicles 20-1, 20-2) or a vehicle that is not currently in operation on the roadway (e.g., one of vehicles 20-3, 20-4, 20-5, 20-6 located in vehicle dispatch center 100). Furthermore, the remote computing system 80 may identify and assign one of the vehicles 20 to the user based on information stored in a blockchain 90, which includes information indicating inventory information of at least one of the suppliers/retailers 110-1, 110-2, 110-3, . . . 110-n (collectively referred to as suppliers/retailers 110). As an example and as indicated by the dashed arrow between the vehicle 20-1 and the communication infrastructure 60, the remote computing system 80 identifies and assigns, based on the vehicle request and the information stored in the blockchain 90, vehicle 20-1 with the user 40. Identifying and assigning a vehicle based on the vehicle request and information stored in the blockchain 90 is described below in further detail with reference to FIGS. 2-3. Furthermore, if the vehicle 20-1 is an autonomous vehicle, the remote computing system 80 may transmit a signal to the vehicle 20-1 with instructions that causes the vehicle 20-1 to, for example, proceed along route 120; unlock the vehicle 20-1 once the user 40 indicates that the vehicle 20-1 has arrived to a location associated with the user 40; and transport the user 40 to the destination associated with the vehicle request. Additionally or alternatively, if the vehicle 20-1 is not an autonomous vehicle, the remote computing system 80 may transmit a signal to a portable device associated with an operator of the vehicle 20-1 with information that causes the portable device to provide directions on a mapping application of the portable device that enables the operator to locate and transport the user 40 to the destination associated with the vehicle request.

With reference to FIG. 1B, an example vehicle routing system 2 is shown. The vehicle routing system 2 is similar to the vehicle routing system 1, but in this embodiment, the remote computing system 80 identifies and assigns vehicle 20-2 to the user 40. Furthermore, the remote computing system 80 determines that vehicle 20-2 does not have a sufficient amount of a particular product associated with the vehicle request. Accordingly, the remote computing system 80 may transmit a signal to the vehicle 20-2 or the operator of vehicle 20-2 with instructions indicating that the vending apparatus 30-2 needs to be supplied with the particular product at supplier/retailer 110-1 (indicated by route 130-1) prior to reaching the location associated with the user 40. Once the vending apparatus 30-2 is sufficiently supplied with the particular product (e.g., an energy drink), the vehicle 20-2 may subsequently proceed along route 130-2 in order to arrive at the location associated with the user 40.

With reference to FIG. 2, a functional block diagram of the remote computing system 80 is shown. In one embodiment, the remote computing system 80 includes a machine learning module 82, a training database 84, and a memory 86. The machine learning module 82 may include one or more processors that are configured to execute instructions stored in the memory 86, which may be a nontransitory computer-readable medium, such as a RAM and/or ROM. Furthermore, the machine learning module 82 may be implemented by various types of standard machine learning systems, such as an HMM classifier and a Support Vector Machine, in order to execute the functionality described herein. Additionally or alternatively, the machine learning module 82 may be implemented by other types of machine learning systems, such as a deep learning network (e.g., a deep neural network, a deep convolutional neural network, a deep belief network, a long short-term memory (LSTM) recurrent neural network, or other similar deep learning network) that is trained by information received from the training database 84.

In one embodiment, the machine learning module 82 receives the vehicle request from the portable device 50 via the network 70, as indicated by a circled 1. As described above, the vehicle request may include at least one of the location information, the date and/or time information, and the user information. In response to receiving the vehicle request, the machine learning module 82 identifies relevant entries in the blockchain 90 based on the user information and, more specifically, the purchase history information portion of the user information, as indicated by a circled 2. As an example, if the purchase history information indicates that the user has purchased energy drinks and various snacks in the past, the machine learning module 82 may identify entries in the blockchain 90 and corresponding suppliers/retailers 110 that are associated with the energy drinks and the various snacks. Additionally, the machine learning module 82 may disregard purchases that occurred beyond a threshold amount of time (i.e., purchases that were made more than a year from the current date), purchases that are inconsistent with the user's purchase history, purchases that are below a threshold value of a ranking or scoring algorithm, etc.

Based on the identified entries of the blockchain 90 and the corresponding suppliers/retailers 110, the location information, the date and/or time information, and/or the user information, the machine learning module 82 is configured to generate a list of relevant products and select one of the vehicles 20 based on the list and/or other criteria, as indicated by a circled 3. In other embodiments, the vehicle request may include pre-selected products (as indicated by the user 40), and as such, the machine learning module 82 may generate the list of relevant products based on the pre-selected products.

As an example, if the machine learning module 82 determines that the list of relevant products includes a particular type of energy drink, the machine learning module 82 may determine, based on information received from the respective vending apparatuses 30, which of the vehicles 20 includes the particular type of energy drink. If one of the vehicles 20 includes the particular type of energy drink, is unoccupied, and/or is within a threshold distance of the user 40, the vehicle 20 may identify and assign that vehicle 20 to the user 40. If none of the vehicles 20 satisfy the above criteria, the machine learning module 82 may identify and assign, based on information received from the respective vending apparatuses, the nearest vehicle 20 to the user 40. Additionally, the machine learning module 82 may identify the nearest supplier/retailer 110 with respect to the vehicle 20, and instruct the remote computing system 80 to transmit a signal that instructs the vehicle 20 to supply the vending apparatus 30 with the particular type of energy drink prior to arriving at the location associated with the user 40. Once the vehicle 20 has supplied the vending apparatus 30 with the particular type of energy drink from the supplier/retailer 110, the machine learning module 82 may instruct the blockchain 90 to generate an entry representing an inventory decrease of the particular type of energy drink of the supplier/retailer 110, as indicated by a circled 4.

In response to the portable device 50 receiving the list of relevant products, the portable device 50 may display graphical user interface (GUI) elements that enable the user 40 to purchase an item from the list of relevant products prior to or once the vehicle 20 has arrived at the location associated with the user 40. If the user 40 purchases an item from the list, the portable device 50 may be configured to transmit payment information to a financial entity 140 via the network 70, as indicated by a circled 5.

With reference to FIG. 3, a flowchart of a control algorithm 300 for identifying and assigning a vehicle to a user is shown. The control algorithm 300 begins at 304 when, for example, the portable device 50 is turned on. At 308, the control algorithm 300 receives, using the remote computing system 80, a vehicle request. At 312, the control algorithm 300 obtains, using the remote computing system 80, contextual information, which includes at least one of location information, date/time information, user profile information, and purchase information. At 316, the control algorithm 300 identifies, using the remote computing system 80, products and/or services in the blockchain 90 based on the contextual information. At 320, the control algorithm 300 selects, using the remote computing system 80, a vehicle 20 based on the contextual information and the identified products and/or services.

At 324, the control algorithm 300 determines, using the remote computing system 80, whether the vehicle 20 includes a sufficient amount of goods associated with the list of relevant products. If so, the control algorithm 300 proceeds to 332; otherwise, the control algorithm 300 proceeds to 328. At 328, the control algorithm 300 routes the selected vehicle to a supplier/retailer 110, supplies the vending apparatus 30 with the relevant product, and creates a new entry in the blockchain 90 representing the update to the inventory. At 332, the control algorithm 300 routes the selected vehicle to the user 40.

At 336, the control algorithm 300 determines whether the user 40 purchases a good and/or service (e.g., payment via BLE signal or other wireless signal). The payment may occur before the selected vehicle reaches the user 40 or when the user 40 is in the selected vehicle. If so, the control algorithm 300 proceeds to 340 and updates the purchase history information accordingly; otherwise, the control algorithm 300 proceeds to 344. At 344, the control algorithm 300 determines whether the user 40 has arrived at the destination associated with the vehicle request. If so, the control algorithm 300 proceeds to 348 and ends; otherwise, the control algorithm 300 proceeds to 336.

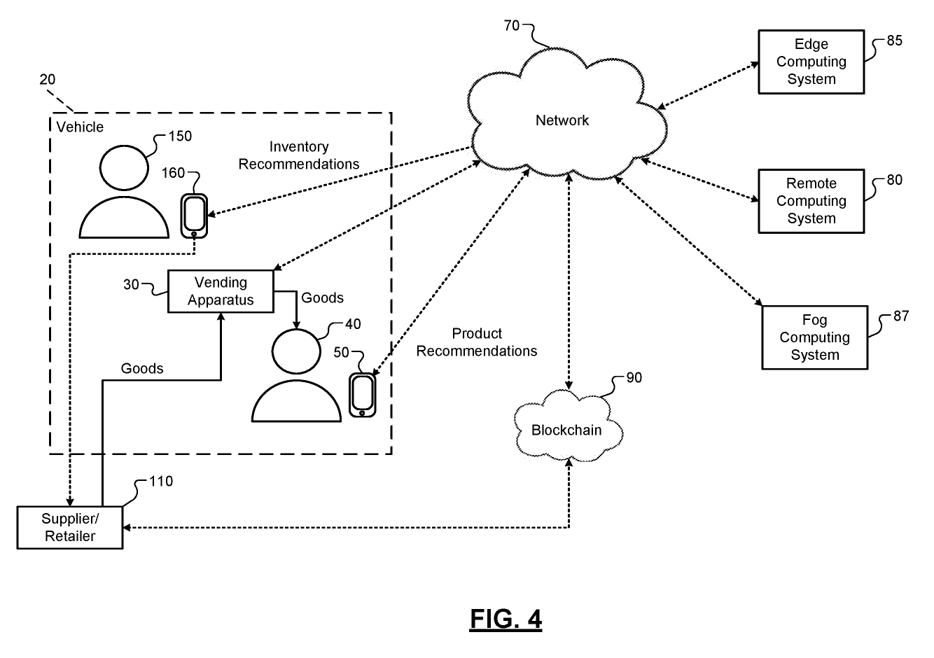

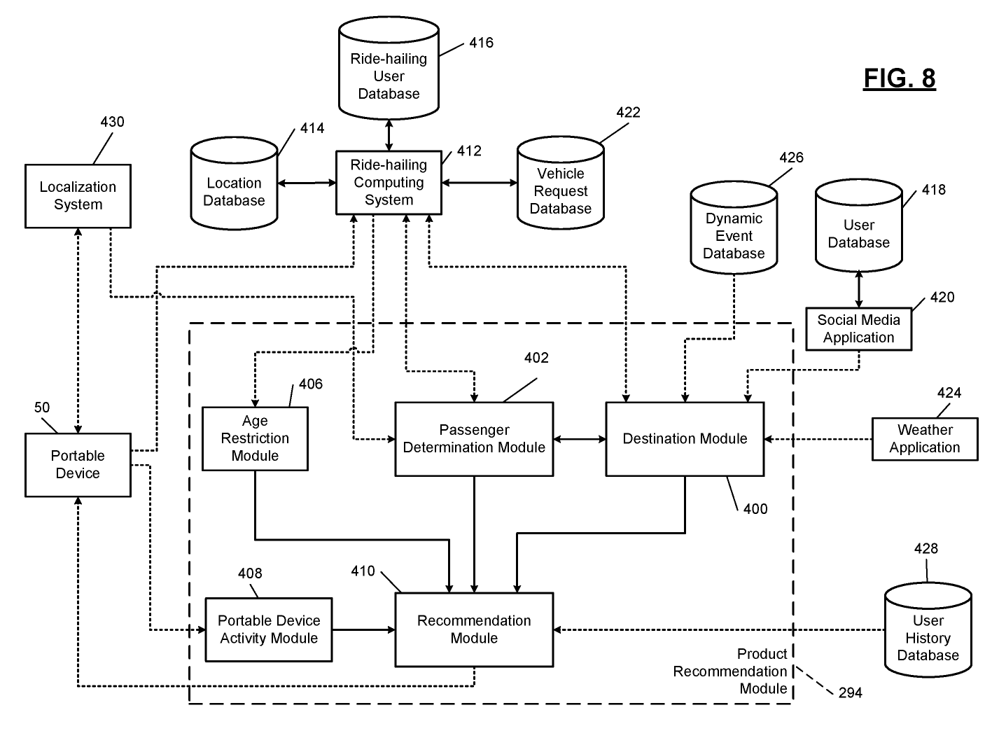

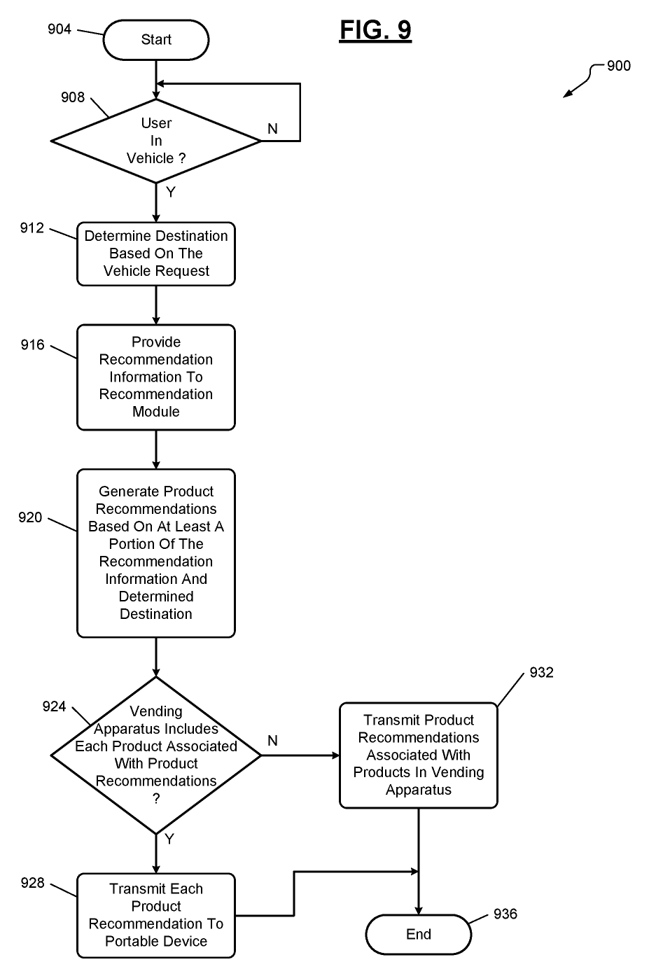

With reference to FIG. 4, a functional block diagram of driver 150 and the user 40 located within the vehicle 20 is shown. The functional block diagram represents, for example, when the vehicle 20, which is operated by driver 150 of a ride-hailing service, is routed to the user 40 and the user 40 enters the vehicle 20. As described above, once the user 40 is assigned to and/or enters the vehicle 20, the user 40 may purchase certain goods and/or services from the vending apparatus 30. Furthermore, the user 40 may receive, using the portable device 50, product recommendations from the remote computing system 80 via the network 70 and/or from the vending apparatus 30. Generating and transmitting product recommendations to the portable device 50 are described below in further detail with reference to FIGS. 8-9. In response to receiving a product recommendation, the user 40 may purchase, via a graphical user interface (GUI) of the portable device 50 and/or the vending apparatus 30, a particular good from the vending apparatus 30.

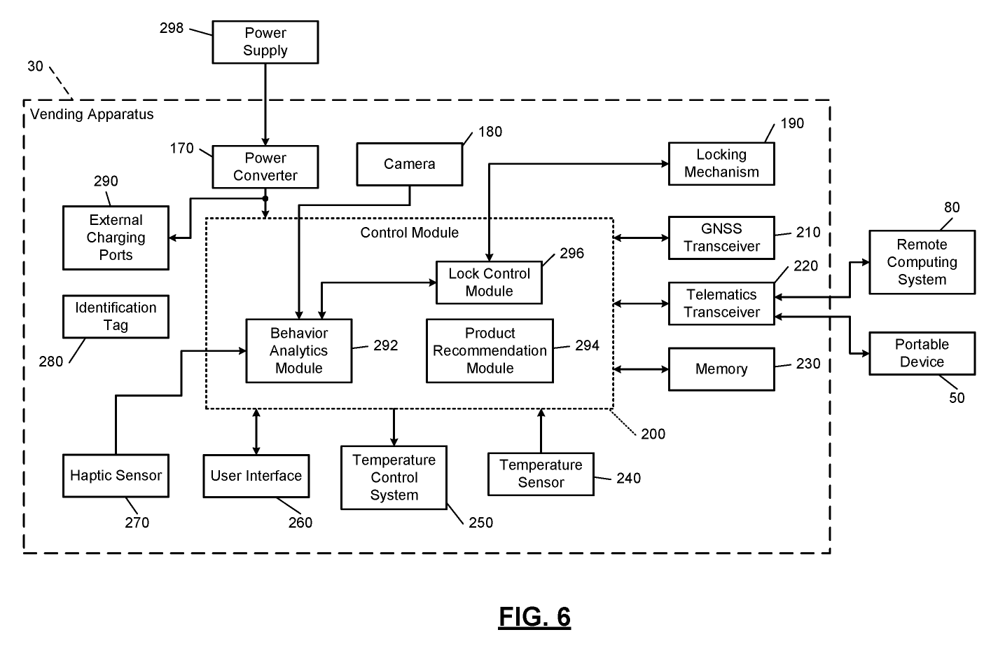

Additionally, the driver 150 may receive, using portable device 160, inventory recommendations from the remote computing system 80 via the network 70 and/or from the vending apparatus 30. As an example, the remote computing system 80 may receive, using a telematics transceiver of the vending apparatus 30 (shown in FIG. 6) and via the network 70, inventory information of the vending apparatus. Based on the inventory information, the remote computing system 80 may identify particular goods that may be of interest to the driver 150. The particular goods may be identified by, for example, a current amount of a particular good available for purchase in the vending apparatus 30, a popularity of a particular good, etc. In response to receiving the inventory recommendation, the driver 150 may order, via the GUI of the portable device 160 and/or the vending apparatus 30, a particular good from the supplier/retailer 110. Additionally, an entry associated with the order may be created in the blockchain 90, as described above.

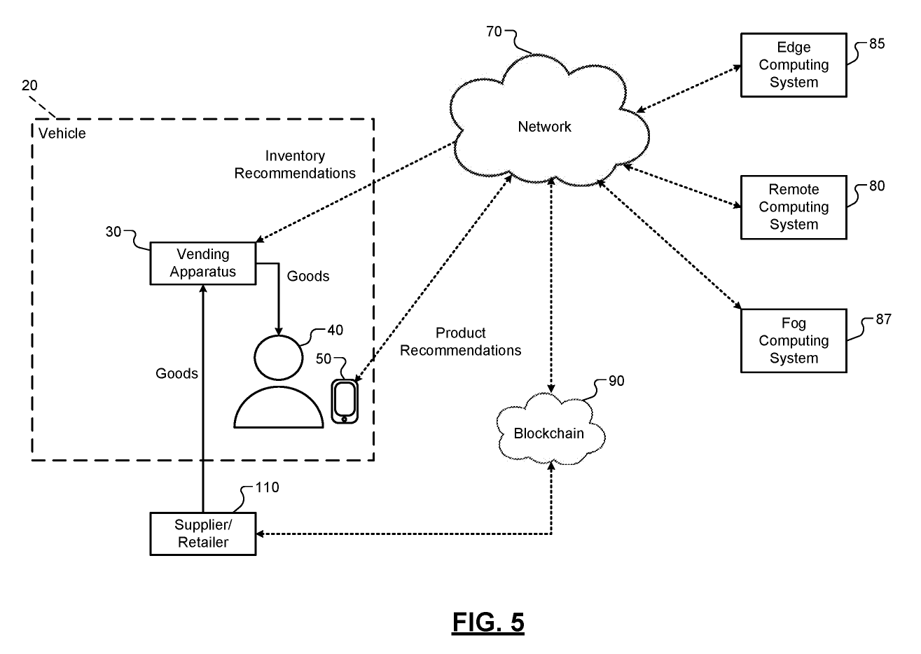

With reference to FIG. 5, another functional block diagram of the user 40 located within the vehicle 20 is shown. FIG. 5 is similar to the functional block diagram described above with reference to FIG. 4, but in this embodiment, the vehicle 20 is implemented by an autonomous vehicle of a ride-hailing service and does not include the driver 150.

With reference to FIG. 6, a functional block diagram of the vending apparatus 30 is shown. The vending apparatus 30 may include a power converter 170, a camera 180, a locking mechanism 190, a control module 200, a global navigation satellite system (GNSS) transceiver 210, a telematics transceiver 220, a memory 230, a temperature sensor 240, a temperature control system 250, a user interface 260, a haptic sensor 270, an identification tag 280, and external charging ports 290. The control module 200 may include a behavior analytics module 292, a product recommendation module 294, and a lock control module 296. The control module 200, behavior analytics module 292, the product recommendation module 294, and the lock control module 296 may be implemented by one or more processors that are configured to execute instructions stored in the memory 230, which may be a nontransitory computer-readable medium, such as a RAM and/or ROM.

The power converter 170 may receive power from a power supply 298 (e.g., a battery of the vehicle 20) and provide a signal with a power value that is suitable for the control module 200. As an example, the power converter 170 may be implemented by any discrete and/or integrated DC-DC converter circuits. Furthermore, the signal may have a power value that enables the vending apparatus 30 to charge, via the external charging ports 290 (e.g., USB ports), the portable devices 50, 160.

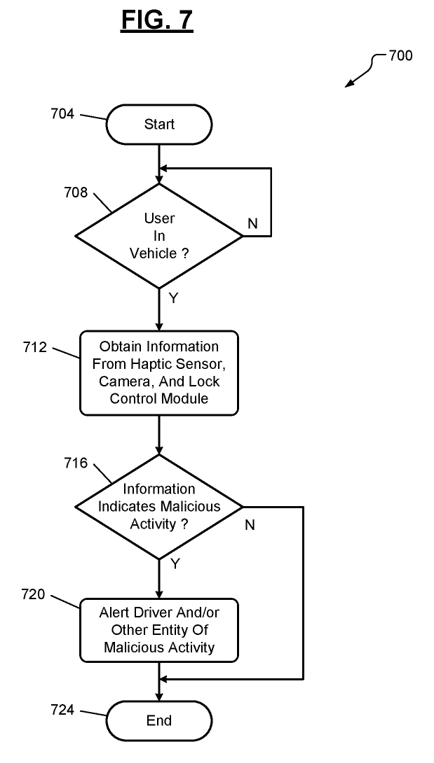

The lock control module 296 is configured to selectively activate and deactivate the locking mechanism 190. As an example, if the control module 200 determines that the user 40 has purchased a particular good that is located within the vending apparatus 30, the lock control module 296 may transmit a signal that causes the locking mechanism 190 to unlock the vending apparatus 30. As another example, the lock control module 296 may transmit a signal that causes the locking mechanism 190 to lock the vending apparatus 30 in response to the behavior analytics module 292 determining that the user 40 is impermissibly attempting to retrieve an item from the vending apparatus 30, as described below in further detail with reference to FIG. 7.

The camera 180 is configured to provide image data to the behavior analytics module 292. Additionally, the behavior analytics module 292 may receive vibration and/or movement data from the haptic sensor 270, which may be implemented by an accelerometer or other similar device. In response to receiving the image data and information from the haptic sensor 270, the behavior analytics module 292 may be configured to determine if the user 40 is impermissibly attempting to retrieve an item from the vending apparatus 30, attempting to vandalize the vending apparatus 30, or perform other types of malicious activity, as described below in further detail with reference to FIG. 7. In other embodiments, the behavior analytics module 292 may be configured to perform occupancy detection algorithms based on the image data in order to, for example, determine a number of occupants in the vehicle 20 and to determine an identity of each occupant in the vehicle 20.

The GNSS transceiver 210, which may be implemented by a global positioning system (GPS) transceiver system, may be configured to obtain location information associated with the vending apparatus 30. In response to receiving the location information, the control module 200 may transmit, via the telematics transceiver 220, the location information to the remote computing system 80.

The temperature sensor 240 is configured to provide temperature data associated with the vending apparatus 30 to the control module 200. Based on the temperature data, the control module 200 may generate a signal that causes the temperature control system 250 to adjust the temperature of the vending apparatus 30. As an example, the vending apparatus 30 may be implemented by a refrigeration system and/or a thermal-electric heating system that is configured to lower and/or raise the temperature of the vending apparatus 30.

The user interface 260 enables the user 40 to make purchases of various goods from the vending apparatus 30. Additionally, the user interface 260 is configured to enable the user 40 to view product recommendations generated by the remote computing system 80. Furthermore, the control module 200 may generate a signal that causes the temperature control system 250 to adjust the temperature of the vending apparatus in response to receiving an input on the user interface 260 (e.g., the user 40 requests to heat and/or cool a beverage located within the vending apparatus 30).

The identification tag 280 is configured to uniquely identify the vending apparatus 30, the driver 150, and/or the vehicle 20. The identification tag 280 may be implemented by, for example, a QR code. Furthermore, when the identification tag 280 is implemented by the QR code, the user 40 may need to scan the QR code using a camera of the portable device 50 prior to purchasing a particular good from the vending apparatus 30.

With reference to FIG. 7, a flowchart illustrating an example control algorithm 700 is shown. The control algorithm 700 begins at 704 when, for example, the user 40 has been assigned to a vehicle 20, as described above with reference to FIG. 3. At 708, the control algorithm 700 determines, using the control module 200, whether the user 40 is in the vehicle 20. If so, the control algorithm 700 proceeds to 712; otherwise, the control algorithm 700 remains at 708 until the user 40 is located inside of the vehicle 20. At 712, the control algorithm 700 obtains, from the haptic sensor 270, the camera 180, and the lock control module 296, vibration and/or movement data, image data, and state information of the locking mechanism 190, respectively.

At 716, the control algorithm 700 determines, using the behavior analytics module 292, whether the obtained information indicates malicious activity (e.g., theft, vandalism, etc.). As an example, the behavior analytics module 292 may determine that the obtained information indicates malicious activity if the image data corresponding to the location and/or movement of the user's head, arms, or other body parts indicates a theft. As another example, the behavior analytics module 292 may determine that the obtained information indicates malicious activity if the image data indicates that the user 40 has impermissibly retrieved a product from the vending apparatus 30. As another example, the behavior analytics module 292 may determine that the obtained information indicates malicious activity if the vibration and/or movement data obtained from the haptic sensor 270 indicates that user 40 is trying to move or dislodge the vending apparatus 30 from the current location within the vehicle 20. As another example, the behavior analytics module 292 may determine that the obtained information indicates malicious activity if the state information indicates that user 40 is trying to manually unlock the locking mechanism 190 when the user 40 has not made a purchase or otherwise obtained authority to access the goods of the vending apparatus 30. If the obtained information indicates malicious activity, the control algorithm 700 proceeds to 720; otherwise, the control algorithm 700 proceeds to 724. At 720, the control algorithm 700 alerts, using the control module 200 and the telematics transceiver 220, the driver 150 and/or other entity of the malicious activity and then ends at 724.

While this embodiment illustrates the control module 200 executing control algorithm 700, in other embodiments, the edge computing system 85 and/or the fog computing system 87 may receive the vibration and/or movement data, image data, and state information of the locking mechanism 190 from the vending apparatus 30. Subsequently, the edge computing system 85 and/or the fog computing system 87 may determine whether the obtained information indicates malicious activity and alert the driver 150 and/or other entity if the obtained information indicates malicious activity, as described above. Using the edge computing system 85 and/or the fog computing system 87 to execute at least a portion of the control algorithm 700 may reduce an amount of computing resources of the control module 200 that are needed to execute the control algorithm 700.

With reference to FIG. 8, a functional block diagram of the product recommendation module 294 is shown. The product recommendation module 294 may include a destination module 400, a passenger determination module 402, an age restriction module 406, a portable device activity module 408, and a recommendation module 410. Each of these modules may be implemented by one or more processors that are configured to execute instructions stored in a nontransitory computer-readable medium, such as a ROM and/or RAM. While the product recommendation module 294 is included within the vending apparatus 30 in this embodiment, the product recommendation module 294 may be included within the remote computing system 80 and/or within a computing system of a ride-hailing service.

In one embodiment, the user 40 may generate, using the portable device 50, a vehicle request for a ride-hailing service in order to arrive at a destination at a particular time (e.g., the user 40 uses a ride-hailing service to go to a pub on a Friday evening). When the assigned vehicle arrives at a location associated with the user 40 (i.e., the originating location), a ride-hailing computing system 412 that received the vehicle request may provide destination information associated with the vehicle request to the destination module 400. In response to receiving the destination information (e.g., an address associated with the pub), the destination module 400 may be configured to, based on information stored in a location database 414, determine characteristics associated with the destination information (e.g., the destination is associated with a business establishment that sells alcoholic beverages). Furthermore, when the vehicle 20 arrives, the ride-hailing computing system 412 may provide user information to the passenger determination module 402, which may be configured to determine the identities and/or demographic information of the passengers based on the user information (e.g., the user 40 is indicated as the sole passenger of the vehicle request, and the user 40 is a young male). As an example, the passenger determination module 402 may reference, via the ride-hailing computing system 412, a ride-hailing user database 416 in order to determine the identities and/or demographic information of the passengers. Based on the determined destination and determined identities and/or demographic data, the recommendation module 410 is configured to identify products that are relevant to the user 40 (e.g., the recommendation module 410 determines that the user 40 may be staying out late and may be interested in an energy drink).

Additionally or alternatively, in response to the destination module 400 receiving the destination information, the destination module 400 may be configured to retrieve the identified passengers from the passenger determination module 402 and execute a social media cross-referencing algorithm. As a specific example, the destination module 400 may determine whether one of the identified passengers is associated with an account in a user database 418 corresponding to a social media application 420. For each of the identified passengers that are associated with a social media account, the destination module 400 may identify each passenger's social media connections and determine, by referencing a vehicle request database 422 associated with the ride-hailing computing system 412, if any of the identified social media connections are associated with a ride-hailing request to the same destination. If so, the product recommendation module 410 may provide a product recommendation to the user 40 via the portable device 50 based on this determination. As a specific example, the user 40 (e.g., a young male) may use the ride-hailing service in order to arrive at, for example, a restaurant on a Friday night. The destination module 400 determines, by referencing the social media application 420, the user database 418, and/or the vehicle request database 422, a second user (e.g., a young female) that is a social media connection of the user 40 is also using the ride-hailing service to arrive at the restaurant. Accordingly, the recommendation module 410 may determine that the user 40 and the second user are meeting at the restaurant for dinner and, more particularly, a date. As such, the recommendation module 410 may generate product recommendations that are associated with breath mints, chewing gum, etc.

While the above embodiment describes a social media cross-referencing algorithm, in other embodiments, the destination module may cross-reference other applications in order to generate the product recommendation, such as a calendar application, a contact application, a messaging application, etc.

Additionally or alternatively, in response to the destination module 400 receiving the destination information, the destination module 400 may be configured to retrieve information from the location database 414 via the ride-hailing computing system 412 in order to make the product recommendation. As an example, the user 40 may transmit a vehicle request with an originating location (i.e., pick-up location) at the user's home. The destination module 400 may be configured to determine, based on information retrieved from the location database 418, that the originating location is associated with the user's home based on the user's billing address, previous ride-hailing requests, and a high frequency of vehicle requests made with the same originating location. Subsequently, the recommendation module 410 may make a product recommendation based on the determined originating location.

Additionally or alternatively, in response to the destination module 400 receiving the destination information, the recommendation module 410 may be configured to retrieve portable device activity information via the portable device activity module 408 in order to make the product recommendation. As an example, when the vehicle 20 arrives at the originating location, the portable device activity module 408 may receive movement data from, for example, an accelerometer and information indicating a usage amount of the portable device 50. Based on the received information, the portable device activity module 408 may determine a rush factor score, which may represent whether the user 40 will be late and/or an amount of time the user 40 needs before he or she is ready to enter the vehicle 20 and use the ride-hailing service. As an example, movement data and/or usage amount information indicating frantic movement and/or nonuse of messaging and browser applications, respectively, may be associated with a higher rush factor score. Accordingly, the recommendation module 410 may make a product recommendation based on the rush factor score. As a specific example, when the vehicle 20 arrives at the originating location, the portable device activity module 408 determines that, based on the rush factor score, the user 40 needs five additional minutes. Furthermore, if the destination module 400 has determined that the user 40 is meeting the second user for a date, as described above, the recommendation module 410 may determine that the user 40 may not have adequately prepared for the date and may recommend, for example, a deodorant product.

Additionally or alternatively, in response to the destination module 400 receiving the destination information, the destination module 400 may be configured to retrieve weather information from the weather application 424 in order to make a product recommendation. As an example, the user 40 may use the ride-hailing service to arrive at a beach. Subsequently, the destination module 400 may obtain weather information associated with the beach from the weather application 424, and the destination module 400 may subsequently determine that, for example, the temperature at the beach is warmer than usual, and it is sunny with a high ultraviolet (UV) index. Subsequently, the recommendation module 410 may generate product recommendations that are associated with sunscreen, sunglasses, cold beverages, etc.

Additionally or alternatively, in response to the destination module 400 receiving the destination information, the destination module 400 may be configured to retrieve event information from a dynamic event database 426 in order to make the product and/or service recommendations. As an example, the user 40 may use the ride-hailing service to arrive at a sporting event that will last for several hours. The recommendation module 410 may generate a service recommendation if, for example, the destination module 400 detects, using the ride-hailing computing system 412, that the user 40 has not reserved a ride back to the originating location. Accordingly, the recommendation module 410 may generate a service recommendation associated with a ride-hailing service for the return trip. Moreover, the recommendation module 410 may specify a pick-up time for the return trip based on an end time of the sporting event, which may be included in the dynamic event database 426.

Additionally or alternatively, in response to the destination module 400 receiving the destination information, the recommendation module 410 may be configured to retrieve purchase and/or ride-hailing history information from a user history database 428 in order to make the product and/or service recommendations. As an example, the user 40 may use the ride-hailing service in order to arrive at a pub on a Friday night. The recommendation module 410 may determine, based on an entry in the user history database 428, that the user 40 usually uses the ride-hailing service to go to a particular restaurant once the pub closes. Accordingly, the recommendation module 410 may generate a service recommendation associated with a ride-hailing service for the trip to the restaurant and may specify a pick-up time for this trip based on the time that the pub closes.

As another example, the user 40 may use the ride-hailing service to arrive at a gym. The recommendation module 410 may determine, based on an entry in the user history database 428, that the user 40 usually purchases a sports drink when using the ride-hailing service to go to the gym. Accordingly, the recommendation module 410 may generate a product recommendation associated with the sports drink when the user 40 enters the vehicle 20. Additionally, if the destination module 400 determines that arriving to the gym will take longer than usual due to, for example, high traffic, the recommendation module 410 may generate a product recommendation associated with a snack in addition to the sports drink, even if the user history database 428 indicates that the user 40 has never purchased a snack while using the ride-hailing service to arrive at the gym.

In response to the passenger determination module 402 determining the identities and/or demographic information of the passengers based on the user information, the age restriction module 406 may be configured to retrieve age information of the passengers in order to filter out certain product recommendations. As an example, the user 40 may use the ride-hailing service in order to arrive at a tailgate for a sporting event. If the age restriction module 406 determines that the user's age is below the legal age for alcoholic consumption, then the age restriction module 406 may prevent the recommendation module 410 from generating product recommendations associated with alcoholic beverages.

In some embodiments, the product recommendation module 294 is in communication with a localization system 430, which may be implemented by a Phone-as-a-key (PAAK) system. The localization system 430 may be configured to estimate the position of the portable device 50 relative to the vehicle 20, determine an identify of the user 40 associated with the portable device 50, determine a number of passengers in the vehicle 20, authorize the user 40 access to vehicle's functions, etc. Example localization systems are described in detail in U.S. Provisional Application No. 62/648,981, filed on Mar. 28, 2018 and assigned to DENSO International America, Inc., which is incorporated herein by reference in its entirety. Accordingly, the passenger determination module 402 may determine the identities and/or demographic information of the passengers based on information received from the localization system 430. Likewise, the age restriction module 406 may be configured to retrieve, from the localization system 430 via the passenger determination module 402, age information of the passenger in order to filter out certain product recommendations. Furthermore, if the user 40 or another passenger purchases a product associated with the product recommendation, the vending apparatus 30 may transmit messages to each of the user 40 and/or other passengers to confirm which account is authorizing payment for the product.

Additionally, the localization system 430 may be configured to determine various characteristics of the portable device 50, such as a type of portable device 50, an operating system of the portable device 50, signatures of the portable device 50, browsing history of the portable device 50, etc. Based on these various characteristics, the product recommendation module 410 is configured to generate product recommendations that are relevant to the user 40 and/or other passengers in the vehicle 20.

With reference to FIG. 9, a flowchart illustrating an example control algorithm 900 is shown. The control algorithm 900 begins at 904 when, for example, the user 40 has been assigned to a vehicle 20, as described above with reference to FIG. 3. At 908, the control algorithm 900 determines, using the control module 200, whether the user 40 is in the vehicle 20. If so, the control algorithm 900 proceeds to 912; otherwise, the control algorithm 900 remains at 908 until the user 40 is located inside of the vehicle 20. At 912, the control algorithm 900 determines, using the control module 200, the destination based on the vehicle request. At 916, the control algorithm 900 provides recommendation information to the recommendation module 410. The recommendation information may include information from at least one of the ride-hailing user database 416, the ride-hailing computing system 412, the user history database 428, the location database 414, the dynamic event database 426, the vehicle request database 422, the social media application 420, the user database 418, the weather application 424, the portable device 50, and the localization system 430. The recommendation information may also include information determined by at least one of the destination module 400, the passenger determination module 402, the age restriction module 406, and the portable device activity module 408. At 920, the control algorithm 900 generates, using the recommendation module 410, a product recommendation based on at least a portion of the recommendation information and the determined destination. At 924, the control algorithm 900 ends.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A system comprising a processor configured to execute instructions stored in a nontransitory memory, wherein the instructions include:
receiving, using the processor, recommendation information from at least one of a ride-hailing computing system and a portable device, wherein the recommendation information includes information associated with a user of the portable device, a time, a date, and portable device activity information;
receiving, using the processor, destination information associated with the user;
generating, using the processor, a product recommendation based on at least a portion of the recommendation information and the destination information;
determining, using the processor, whether a vending apparatus located in a vehicle includes a product associated with the product recommendation; and
in response to determining that the vending apparatus includes the product, transmitting, using the processor, the product recommendation to the portable device.

2. The system of claim 1, wherein generating the product recommendation further comprises:
determining, using the processor, a destination and characteristics associated with the destination based on the destination information; and
generating, using the processor, the product recommendation based on the characteristics associated with the destination.

3. The system of claim 1, wherein generating the product recommendation further comprises:
identifying, using the processor, the user;
determining, using the processor, a destination based on the destination information;
determining, using the processor, whether the user is associated with a social media account;
in response to determining that the user is associated with the social media account, determining, using the processor and by referencing a vehicle request database associated with the ride-hailing computing system, whether a social media connection of the user has made a vehicle request, wherein the vehicle request includes destination information corresponding to the destination; and
generating, using the processor, the product recommendation based on whether the social media connection of the user has made the vehicle request.

4. The system of claim 1, wherein generating the product recommendation further comprises:
determining, using the processor, a destination based on the destination information;
retrieving, using the processor and by referencing a weather application, weather information associated with the destination; and
generating, using the processor, the product recommendation based on the weather information.

5. The system of claim 1, wherein generating the product recommendation further comprises:
determining, using the processor, a rush factor score based on the portable device activity information, wherein the portable device activity information represents at least one of movement data associated with the portable device and usage data associated with the portable device; and
generating, using the processor, the product recommendation based on the rush factor score.

6. The system of claim 1, wherein the instructions further comprise generating, using the processor, a service recommendation based on at least the portion of the recommendation information and the destination information.

7. The system of claim 6, wherein generating the service recommendation further comprises:
determining, using the processor, a destination based on the destination information;
determining, using the processor and by referencing a dynamic event database, whether the destination is associated with an event;
determining, using the processor and by referencing a vehicle request database, whether the user has made a vehicle request associated with an end time of the event; and
in response to determining that the user has not made the vehicle request, generating, using the processor, the service recommendation associated with a ride-hailing service corresponding to the end time of the event.

8. A system comprising a processor configured to execute instructions stored in a nontransitory memory, wherein the instructions include:
receiving, using the processor, a vehicle request from a portable device;
obtaining, using the processor, contextual information, wherein the contextual information includes:
user information associated with a user of the portable device, wherein the user information includes user profile information and purchase history information; and
route information, location information, and time information associated with the vehicle request;
identifying, using the processor, at least one product based on at least one of the vehicle request and the contextual information;
selecting, using the processor, a vehicle from a plurality of vehicles based on the at least one product;
determining, using the processor, whether the vehicle includes the at least one product; and
in response to the vehicle not including a threshold amount of the at least one product, transmitting, using the processor, a request to at least one of the vehicle and a portable device associated with an operator of the vehicle, wherein:
the request is configured to cause the at least one of the vehicle and the portable device to generate an output indicating that the vehicle needs to be supplied with the at least one product prior to arriving at a location associated with the user.

9. The system of claim 8, wherein the instructions include:
in response to a user of the portable device making a purchase of the at least one product, updating, using the processor, a blockchain network based on the purchase.

10. The system of claim 8, wherein selecting the vehicle further comprises:
retrieving, using the processor, inventory information associated with each vehicle of the plurality of vehicles;
retrieving, using the processor, location information associated with each vehicle of the plurality of vehicles; and
selecting, using the processor, the vehicle based on the location information associated with each vehicle of the plurality of vehicles and the inventory information.

11. The system of claim 10, wherein selecting the vehicle further comprises retrieving, using the processor, operation information associated with each vehicle of the plurality of vehicles.

12. The system of claim 8, wherein the instructions include:
in response to the vehicle not including the threshold amount of the at least one product, identifying, using the processor, at least one of a supplier and retailer that includes the at least one product.

13. The system of claim 12, wherein the request is configured to cause the vehicle to automatically proceed to a location associated with at least one of the supplier and the retailer.

14. The system of claim 8, wherein the purchase history information represents purchases that are associated with the user and that were made within a threshold period of time.

15. An apparatus comprising:
a processor configured to execute instructions stored in a nontransitory memory, wherein the instructions include:
receiving, using the processor, motion data from a haptic sensor, wherein the motion data indicates at least one of a vibration of a vending apparatus and movement of the vending apparatus;
receiving, using the processor, image data from a camera;
determining, using the processor, whether the vending apparatus is subject to malicious activity based on at least one of the motion data and the image data; and
in response to determining that the vending apparatus is subject to malicious activity:
activating, using the processor, a locking mechanism of the vending apparatus;
generating, using the processor, an alert corresponding to the malicious activity; and
transmitting, using the processor, the alert to at least one of (i) a portable device associated with an operator of a vehicle that includes the vending apparatus, and (ii) a control module of the vehicle.

16. The apparatus of claim 15, wherein the instructions include:
determining, using the processor, state information associated with the locking mechanism.

17. The apparatus of claim 16, wherein determining that the vending apparatus is subject to malicious activity further comprises:
determining, using the processor, the image data corresponds to at least one of a location and a movement of a user that is associated with the malicious activity.

18. The apparatus of claim 16, wherein determining that the vending apparatus is subject to malicious activity further comprises:
determining, using the processor, the image data corresponds to a user impermissibly retrieving products from the vending apparatus.

19. The apparatus of claim 16, wherein determining that the vending apparatus is subject to malicious activity further comprises:
determining, using the processor, the motion data corresponds to a user attempting to move the vending apparatus from a first location.

20. The apparatus of claim 16, wherein determining that the vending apparatus is subject to malicious activity further comprises:
determining, using the processor, the state information corresponds to a user attempting to impermissibly access products of the vending apparatus.
